(19) United States
(12) Patent Application Publication
(10) Pub. No.: US 2011/0055731 A1
(43) Pub. Date: Mar. 3, 2011

(54) CONTENT DISTRIBUTION OVER A NETWORK

(76) Inventor: Andrew Echenberg, Toronto (CA)

(21) Appl. No.: 12/870,197

(22) Filed: Aug. 27, 2010

Related U.S. Application Data
(60) Provisional application No. 61/239,267, filed on Sep. 2, 2009.

(51) Int. Cl. G06F 3/00; G06F 15/16

(52) U.S. Cl. 715/756; 709/217

(57) ABSTRACT

There is described a content distribution network comprising at least one server adapted to generate a substantially real-time instance of a root website and generate host site data in a frame of a host website, the frame comprising content of the host website and at least one blank segment; and at least one user machine connected to the network, the user machine having at least one application running on a processor for displaying the frame comprising content of the host website and having the real-time instance of the root website embedded therein via the at least one blank segment, thereby allowing access to the root website while remaining on the host website, wherein embedding the substantially real-time instance of the root website into the frame of the host website is done on one of the at least one server and the user machine.

### CROSS-REFERENCE TO RELATED APPLICATIONS

This application claims priority under 35 USC §119(e) of U.S. Provisional Patent Application bearing Ser. No. 61/239,267, filed on Sep. 2, 2009, the contents of which are hereby incorporated by reference.

### TECHNICAL FIELD

The present invention relates to the field of data distribution over a network, and particularly to the distribution of content from a root website via a host website.

### BACKGROUND OF THE ART

With the advent of personal computers, the growth of digital content has accelerated online user consumption. Mechanisms to enhance sharing and access to data are becoming more critical for content creators and consumers alike.

The time and effort required to develop and deploy technologies to distribute data across multiple digital platforms can be extremely demanding, technically challenging and economically taxing. Tasks ranging from development of technologies across platforms and/or environments, display optimization and ongoing updates create a demanding and complicated workload for any individual and/or group.

Therefore, there is a need for an improved method of distributing content.

### SUMMARY

In accordance with a first broad aspect, there is provided a method for distributing content over a network, the method comprising: generating a substantially real-time instance of a root website; generating host site data in a frame of a host website, the frame comprising content of the host website and at least one blank segment; and embedding the real-time instance of the root website in the host website frame via the at least one blank segment, thereby allowing access to the root site while remaining on the host website.

In accordance with a second broad aspect, there is provided a content distribution network comprising: at least one server adapted to generate a substantially real-time instance of a root website and generate host site data in a frame of a host website, the frame comprising content of the host website and at least one blank segment; and at least one user machine connected to the network, the user machine having at least one application running on a processor for displaying the frame comprising content of the host website and having the real-time instance of the root website embedded therein via the at least one blank segment, thereby allowing access to the root website while remaining on the host website, wherein embedding the substantially real-time instance of the root website into the frame of the host website is done on one of the at least one server and the user machine.

The expression “instance of a website” refers to a representation of the content of a website in an environment other than the website itself and differs from an iFrame (or Inline Frame) in that a reproduction of the site content is present in the instance. An iFrame is an HTML structure that allows another HTML document to be inserted into an HTML page. The iFrame is set up as a window frame of a specified size that scrolls along with the rest of the page, but the iFrame's content can itself be scrolled if it is larger than the iFrame window. In the case of the instance of a website, a window may also be present, but the content presented in the window is a reproduction of the actual website, not the website itself. In order to access a website and its associated content, a user usually has to enter the website address or URL (Uniform Resource Locator) in a web browser. The user then accesses directly the website via a network, such as the Internet. An instance of a particular website allows the user to access the whole content of the particular website without directly connecting to the particular website, but rather via another website, and without leaving this other website. The content that can be accessed through an instance of a website comprises text, hyperlinks, videos, audio, pictures, images, and the like.

A real-time instance or substantially real-time instance of a website refers to a substantially real-time representation of a website. Any modification to the content of the website is reflected in the real-time instance of the website in substantially real-time.

A frame of a website is a webpage of the website which is divided into a plurality of segments. At least one of the segments is blank so that content different from the website content may be inserted or embedded therein. At least another segment comprises content from the website.

A host site is a website currently being perused by a user, while a root site is the site from which content is taken to generate the instance of a website. There are no limits as to which types of websites may constitute either the host website or the root website.

### BRIEF DESCRIPTION OF THE DRAWINGS

Further features and advantages of the present invention will become apparent from the following detailed description, taken in combination with the appended drawings, in which:

FIG. 1 is a block diagram of a system for distributing content over a network in accordance with an embodiment;

FIG. 2 is a flow chart of a method for displaying a substantially real-time instance of a root website via a host website, in accordance with an embodiment;

FIG. 3 is a flow chart of a method for distributing content over a network, in accordance with an embodiment;

FIG. 4 is a flow chart of a method for distributing content over a network using an application with an embedded browser (using native code within the application and/or a combination of a browser and native code);

FIG. 5 illustrates a frame of the Facebook™ website which only comprises content from the Facebook™ website, in accordance with an embodiment;

FIG. 6 illustrates a frame of the Facebook™ website which comprises content from the Facebook™ website and from Yourmagz™ website, in accordance with a further embodiment;

FIG. 7 illustrates a Facebook™ webpage which comprises an instance of another website, in accordance with an embodiment;

FIG. 8 illustrates a Facebook™ webpage which comprises a feed, in accordance with an embodiment;

FIG. 9 illustrates an interface which allows a user to extend the distribution of his or her content through the network system, in accordance with an embodiment; and

FIG. 10 illustrates an interface which allows a user to extend the distribution of his or her content through the network system, in accordance with another embodiment.

### DETAILED DESCRIPTION

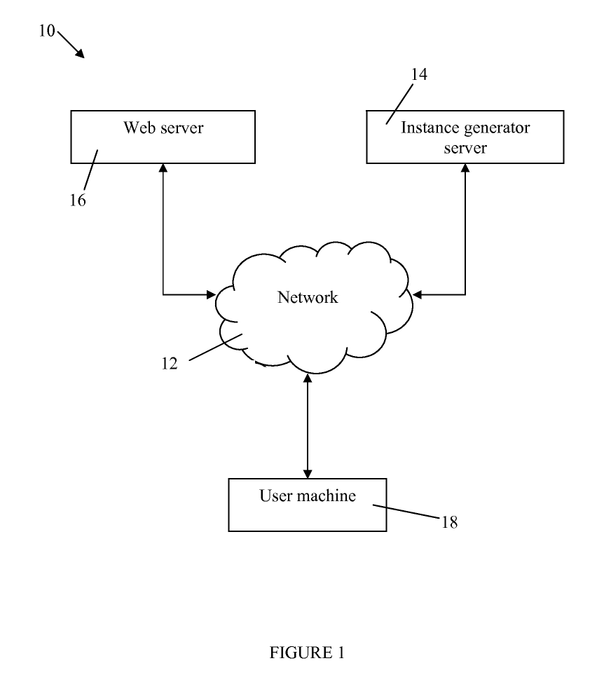

FIG. 1 illustrates one embodiment of a system 10 for distributing content over a network 12. The network can be any kind of telecommunication network such as the Internet, a Wide Area Network (WAN), a Metropolitan Area Network (MAN), and the like. The system 10 comprises an instance generator server 14, a web server 16, and a user machine 18 which are connected to the network 12. The instance generator server 14 hosts a first website (root website) and the web server 16 hosts a second website (host website). Alternatively, the root website may be hosted on a different server and the instance generator server is in communication with this different server to access content of the root website.

The instance generator server 14 is adapted to generate a substantially real-time instance of the root website in substantially real-time so that modifications made to the content of the root website are reflected in substantially real-time in the instance. The web server 16 is adapted to generate a frame of the host website. The frame comprises a webpage of the host website which is divided into a plurality of segments. At least one segment is blank and at least another segment comprises content from the host website. The instance generator server 14 and the web server 16 are also adapted to send data representative of the substantially real-time instance of the root website and data representative of the frame of the host website, respectively, over the network 12.

The user machine 18 comprises a processor, a memory, a display unit and communication means, and is adapted to receive the data sent by the instance generator server 14 and the web server 16 over the network 12. The user machine 18 is further adapted to render a webpage of the host website by combining the received data representative of the substantially real-time instance and the received data representative of the frame of the host website. The generated webpage of the host website comprises content from the host website and the substantially real-time instance of the root website. The user of the machine 18 has access to the whole content of the root website via the instance of the root website while being only connected to the host website.

In one embodiment, some content of the instance does not change while the user navigates through the instance of the root website. Such content is referred to as static content. Headers and menus are examples of static content. In this case, the instance generator server 14 and the web server 16 are connected together over the network 12 and the static content of the root website is sent to the web server 16 via the network 12. The web server 12 is then adapted to combine the static content of the root website with content of the host website in order to generate the frame of the host website. In this case, the frame of the host website comprises content of the host website and static content of the root website.

In one embodiment, the system 10 allows for two-way communication between the instance generator server 14 and the user computer 18 so that a user can delete, add and/or modify content from the substantially real-time instance of the root website while being connected to the host website. In this case, the instance generator server 14 is adapted to receive data from the user machine 18 and update the content of the root website in accordance with the data received from the user. Furthermore, the instance generator server 14 updates the root website each time that new content is added to the root website or modifications to the content are made. This updated instance is then made available to all of the users via the host website and/or a substantially real-time instance of the root website.

In another embodiment, data can only be entered via the root website. In this case, a user connects to the website via his web browser in order to add new content to the root website or modify the content of the first website.

It should be understood that the term “server” refers to any machine provided with at least a processor, a memory, and communication means.

In one embodiment, the substantially real-time instance of the root website generated by the instance generator server 14 is sent to the web server 16. In this case, the web server is adapted to generate the webpage of the root website in addition to generating the frame of the host website. The webpage comprising the substantially real-time instance of the root website and the frame of the host website is then sent to the user computer 18 which is adapted to display the webpage on the display unit.

A user desiring to send/receive content from a root website via a host website either adds an application to their network 12 and/or downloads a file, embeddable or not. The file can be in any format which allows for the reception and display of an instance of a website in substantially real-time. For example, the file can be Flash™, Miscrosoft Silverlight™, Java™ or a JavaScript™ file.

The application allows the processor of the machine to combine data representative of a frame of a host website with data representative of an instance of a root website in order to render a webpage of the host website comprising the instance of the root website. The application may be accessed from the host website or any other website via the network 12, may be received by email, etc.

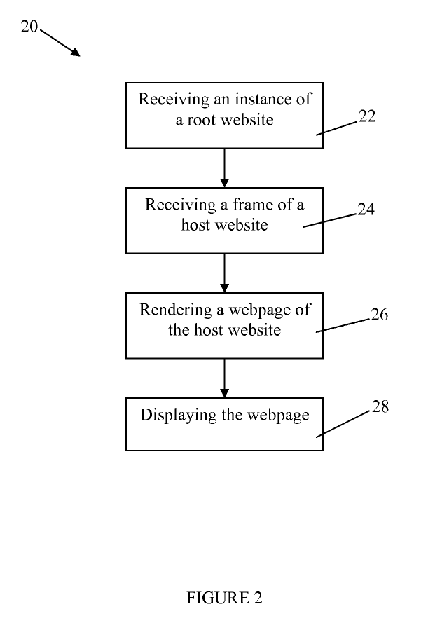

In order to access content of the root website, the user first connects to the host website via the network 12. The user then displays the substantially real-time instance of the root website on the user machine 18 in accordance with the method 20 described in FIG. 2. By selecting from the host website to display the root website via the host website, the user machine 18 receives data representative of a substantially real-time instance of the root website from the instance generator server 14 in substantially real-time (step 22), and data representative of a frame of the root website from the web server 16 (step 24). The processor of the user machine 18 accesses data representative of the substantially real-time instance of the root website and the frame of the host website and renders a webpage of the host website by combining the data representative of the substantially real-time instance of the root website and the data representative of the frame of the host website (step 26). The rendered content comprises content from the host website and the substantially real-time instance of the root website. For example, the content of the host website contained in the rendered content may comprise headers, menus, and the like. The last step 28 of the method 20 consists of displaying the rendered content on the user display unit. Through the substantially real-time instance, the user has access in substantially real-time to part of or the entire content of the root website while being connected to the host website and not to the root website. The user can navigate within the instance to access the content of the root website while being connected to the host website.

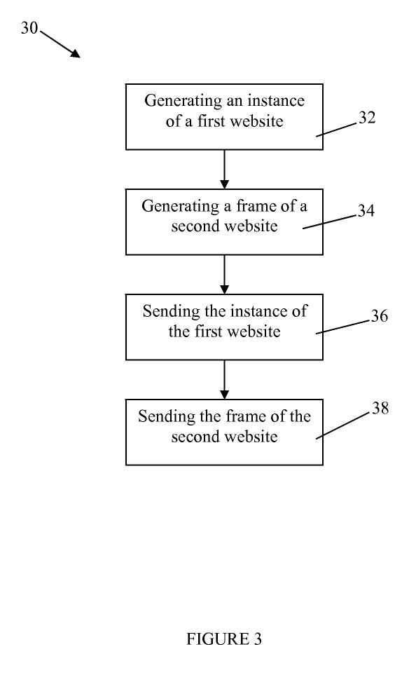

FIG. 3 illustrates one embodiment of a method 30 for distributing content via a network. When the user is connected to the host website and wants to access content of the root website via the host website, the user machine 18 sends a request to both the instance generator server 14 and the web server 16. After the reception of the request, the instance generator server 14 generates a substantially real-time instance of the root website (step 32) and the web server 16 generates a frame of the host website (step 34). If the root website and the host website are not hosted on the instance generator server 14 and the web server 16, respectively, then the instance generator server 14 and the web server 16 download data required for generating the substantially real-time instance and the frame, respectively, from the server hosting the root website and the host website, respectively. Data representative of the generated instance is sent at step 36 from the instance generator server 14 to the user machine 18 and data representative of the generated frame is sent at step 38 from the web server 16 to the user machine 18. The data received by the user machine 18 is combined together by the processor of the user machine 18 to render a webpage of the host webpage. The rendered webpage comprises content from the host website and the substantially real-time instance of the root website.

In one embodiment, when the user navigates within the substantially real-time instance of the root website through the rendered webpage, data is exchanged between the user machine 18 and the instance generator server 14 in substantially real-time so that the instance displayed on the user machine is a substantially real-time representation of the content of the root website. When the user navigates through the instance, requests are sent by the user machine 18 to the instance generator server 14 which sends in substantially real-time content of the root website to the user machine 18 in response to the requests. Since communication between the user machine 18 and the instance generator machine 14 occurs in substantially real-time, new content added to the root website or modifications made to the content of the root website are made available to the user in substantially real-time through the instance of the root website displayed on the user display unit.

In one embodiment, the instance of the root website is independent of the particular website through which it will be accessed. In this case, the instance generator server 14 generates a single instance of the root website and this single instance is to be combined with the frame of any website. In another embodiment, the instance of the root website is dependent on the website through which it will be accessed. In this case, the instance generator server 14 generates an instance of the root website which is adapted to the particular website through which the instance is be to displayed.

In one embodiment, the frame of the host website comprises content from the root website. This content can comprise unchanging content displayed on the user display unit which does not change while the user navigates within the substantially real-time instance of the root website. For example, the unchanging content of the root website included in the frame of the host website can comprise headers, menus, and the like. In this case, the web server 16 is adapted to include the unchanging content of the root website in at least one segment of the frame of the host website while generating the frame.

In one embodiment, unchanging content of the host website is sent by the instance generator server 14 to the web server 16 to be included in the frame of the host website. The host website may have secondary websites within it, and the unchanging content can comprise a menu allowing a user to search for a particular secondary website, a menu describing the categories of the secondary website, and the like.

The following is an example illustrating the above, using a magazine creation website as the root website and a social community website, such as Facebook™, MySpace™, or the like, as the host website. The root website comprises a parent website and at least one secondary website. The secondary websites are created and accessed through the parent website. For example, the website address of the parent website can be www.magazine.com. Users interested in developing a magazine may create their website via the parent website. For example, a user creates a magazine about patents via the www.magazine.com website and this secondary website can be allocated the following address: www.patent.magazine.com or www.magazine.com/patent. In this case, a user may access an instance of the parent website or of the secondary website via the host website of Facebook™.

A root site may comprise any type of content such as text, images, pictures, videos, and the like. The root website also allows distribution of the content of other root sites such as www.patent.magazine.com or www.magazine.com via the Facebook™ website without requiring the editors of the other root sites to create a Facebook™ application adapted to display the content of their root site within the Facebook™ website.

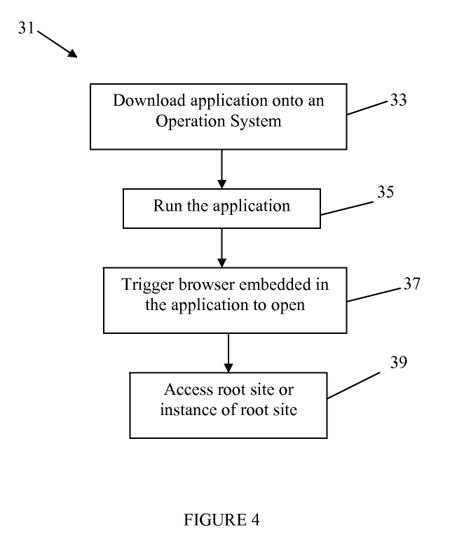

FIG. 4 illustrates one embodiment of a method 31 of accessing a root site or an instance of a root site from an application hosted on an operating system. The operating system may be that of a personal computer, a personal digital assistant such as an iPhone™ or a Blackberry™, a laptop computer, or any other device which runs a specific data processing system. The application has a browser embedded therein, and the browser will lead the user to a root site or a substantially real-time instance of a root site. In one embodiment, the browser renders the given content, either of the site or the real-time instance. Alternatively, the content of the real-time instance and/or site may be rendered through native application code and/or a combination of the browser and native code. In yet another case, there may not be a browser and content is only generated through native code. Examples of native application code are Objective-C for the iphone™ and Java for the Android™. In one example, an article list may be rendered in native code and an article rendered in the browser. In another example, both the site's content and the article are rendered in native code within the application as opposed to simply having everything rendered within the browser. Other variants of these embodiments will be readily understood by those skilled in the art.

In accordance with the method, an application is downloaded onto an operating system 33. When the application is run 35, the web browser is triggered 37 and opens to the root site or the instance of the root site 39. In this embodiment, the application may have the ability to have root site variables passed through upon being downloaded, thereby allowing a root site and/or substantially real-time instance of a root site to be added to the application inside the browser element, or using the application's native code, and/or a combination of application native code and an embedded browser before being opened for the first time. From within the application, the user has access in substantially real-time to part of or the entire content of one or many root websites and/or substantially real-time instances of a root site, thereby having access to content of the respective root sites.

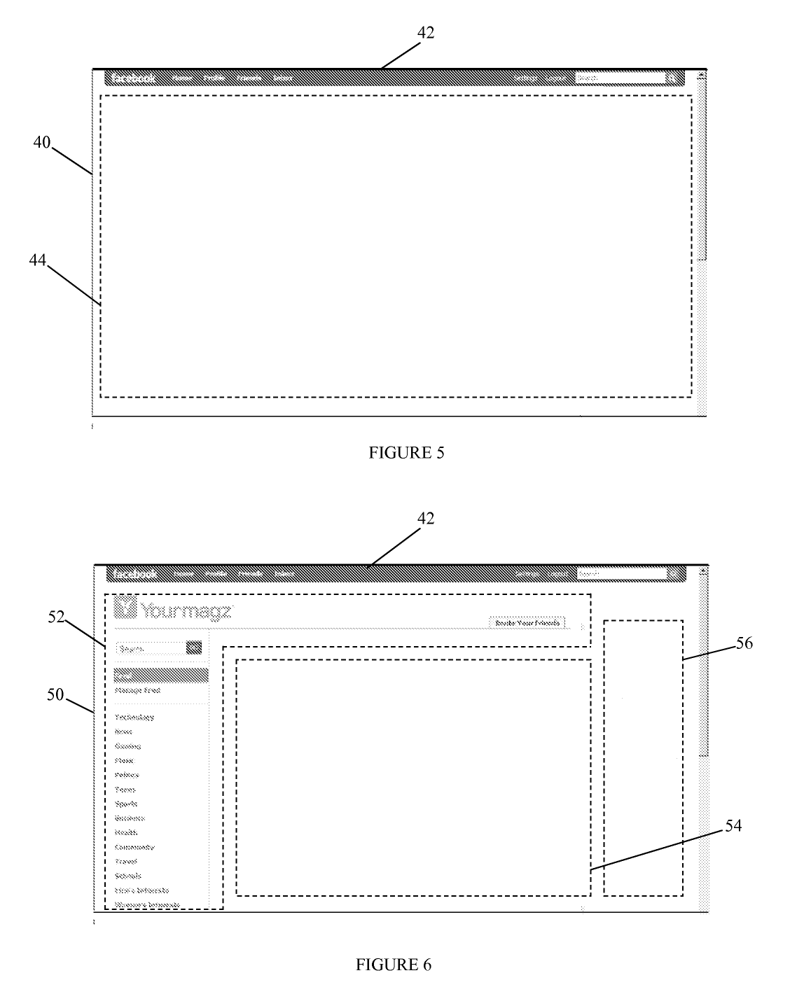

FIG. 5 illustrates an exemplary embodiment where a frame 40 of the Facebook™ website is generated by the Facebook™ server when a user of Facebook™ requests access to the content of the Yourmagz™ website through the Facebook™ website. The frame 40 comprises a segment 42 and a blank segment 44. Segment 42 comprises content from the Facebook™ website. In this example, the content of segment 42 comprises functionalities of the Facebook™ website such as “home”, “profile”, “friends”, inbox”, “settings”, “logout”, and “search” which allow users to display the content of their Facebook™ account. The blank segment 44 represents the space available for inserting the instance of the root website.

FIG. 6 illustrates another embodiment of a frame of the Facebook™ website which is generated by the Facebook™ server when a user of Facebook™ requests access to the content of the Yourmagz™ website through the Facebook™ website. The frame 50 includes four segments, namely segments 42, 52, 54, and 56. Segment 42 comprises content of the Facebook™ website while segment 52 comprises content from the Yourmagz™ website. For example, segment 52 may comprise a menu grouping the different categories of secondary root sites available via the Yourmagz™ website. Segment 54 is blank so that an instance of the Patentmagz group site (a secondary root site) can be inserted therein. Segment 56 may comprise content from the Facebook™ website such as advertising for example.

The server of the Facebook™ website generates the frame 40, 50 and the server of the Yourmagz™ website generates the instance of the Patentmagz website in substantially real-time. The frame 40, 50 and the instance are sent to the user computer 18 in substantially real-time. The user computer 18 generates a webpage of the Facebook™ website by inserting the instance of the Patentmagz website in the blank segment of the frame 40, 50.

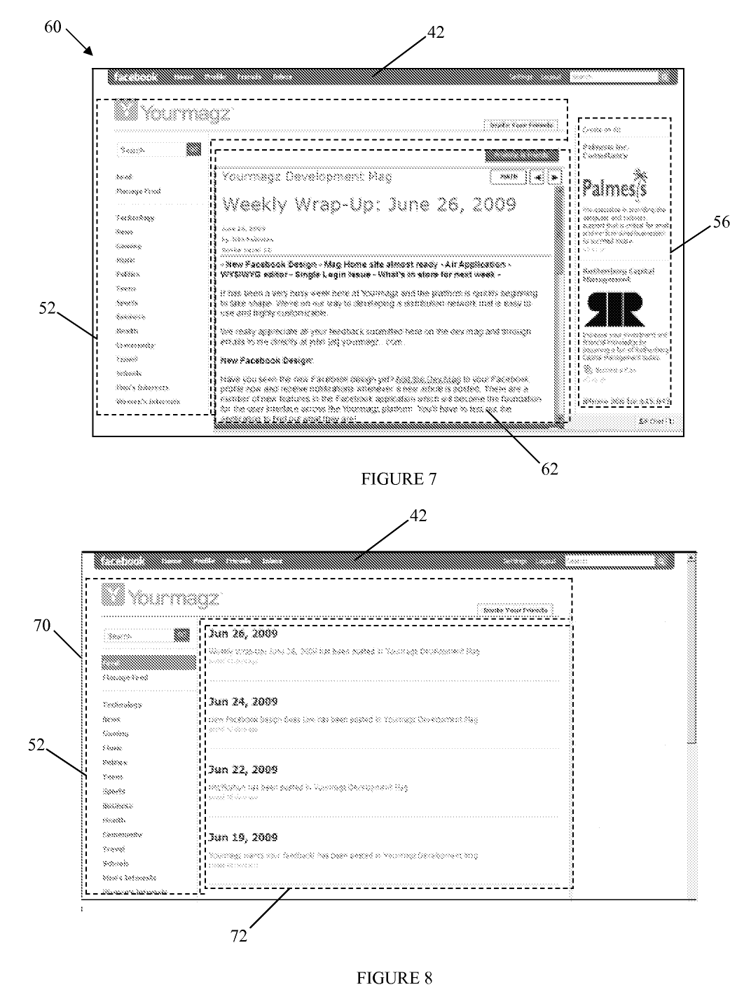

FIG. 7 illustrates one embodiment of a webpage 60 of the Facebook™ website generated by the user computer 18. The webpage results from the combination of the frame 50 with an instance of the Patentmagz website. The webpage 60 comprises the segments 42, 52, and 56 of the frame 50 and the instance 62 of the Patentmagz website.

In order to access the group sites (or secondary root websites) contained in the Yourmagz™ website, a Facebook™ user downloads an application. Once the application has been installed, the user may access the Yourmagz™ website via the Facebook™ website. By accessing the Yourmagz™ website via the Facebook™ website, the user may search for a specific secondary root site hosted by the Yourmagz™ website. Once a secondary root site of choice has been identified, an instance of the root website is displayed in the Facebook™ webpage.

In one embodiment, the members of a root site can add content to the root site via the instance of the root site on Facebook™. While being connected to Facebook™, a user may send comments about a particular article or add a new article to a root site, for example. In this case the Yourmagz™ server is adapted to receive the instructions from the user machine 18 and to update the content of the root website in accordance with these instructions. When new content is added to the root website or any content modification is made to the content of the website either directly via the root website or via an instance of the root website, the Yourmagz™ website generates an updated instance of the root site, which is made available to the Facebook™ users. Because the instance of the root site is a substantially real-time representation of the content of the root website, any new content or any modification to the content is provided to the Facebook™ users in substantially real-time. For example, members of a particular group site may read a new article posted on the group site via Facebook™ and they may react to the newly posted article by sending comments which are made available to all of the other members of the group site in substantially real-time.

In one embodiment, when new data is uploaded to a given root site that resides on a social network website, the end user is notified of new data through any notification mechanisms such as feeds, direct messages, pop-ups, email, or the like. FIG. 8 illustrates a Facebook™ webpage 70 generated by the user computer 18 by combining a frame of the Facebook™ website and an instance of a group site. The webpage 70 comprises a feed 72 which notifies the Facebook™ user of new articles for the magazines for which the user is a member. Data from the feed is updated in substantially real-time and users are notified of new content via other feeds (including 3^{rd} party feeds), direct messages, pop-ups, email as well as other notification mechanisms. Once users select an item within the feed, they are presented with the requested data from the root site.

In one embodiment, the feed has the ability to recommend content to users based on their profiled data which includes their past consumption of content, personal profiled information, information regarding individuals the user is associated with, information about the user provided by the social community website server, as well as other user specified information.

In one embodiment, the instance generator server 14 is adapted to analyze user preferences, interests, age, content they engage in, categories of content they are interested in, geo-location, information provided by the web server 16, content consumed, content they have actively engaged, keywords of groups viewed, descriptions of groups actively engaged with, sex, age, personal interests, hobbies, information of users that a given individual is associated with, as well as other user specific data, and to offer content creators and participants the ability to distribute the given content to targeted audiences across social networks through the given data group sites and data application extensions.

In one embodiment, a user can search for different group sites by section category, search, a feed, or by manually navigating through the application extension interface itself. Titles, text and links to content of the available group sites are listed alongside a group's associated image. Icons to add/subscribe, remove, access the content of a group site, promote the group to other users, and/or request additional information are also made available to an end user within the Facebook™ webpage.

In one embodiment, the user downloads an embeddable file in order to access the content of a root website via a host website. The title of the root site may be visible at the top of the embeddable file. Specific content data contains a title and text within the given file. The end user can access the root site by selecting content items within the interface, data modules and/or from icons within a navigation bar. The user can also access categories of content, archives, invite requests, login/sign-up credentials, member lists, upload content and other data from the icons displayed within the file, and the like. These features are also available through an application extension.

In one embodiment, the system 10 allows a user to see a live preview of the root site and access the code for the given embedded file for promoting a given root site. The given embedded file can be represented both with images attached to given hyperlinks, with linear hyperlinks, as well as with other formats based on the size and presentation of the hosted environment.

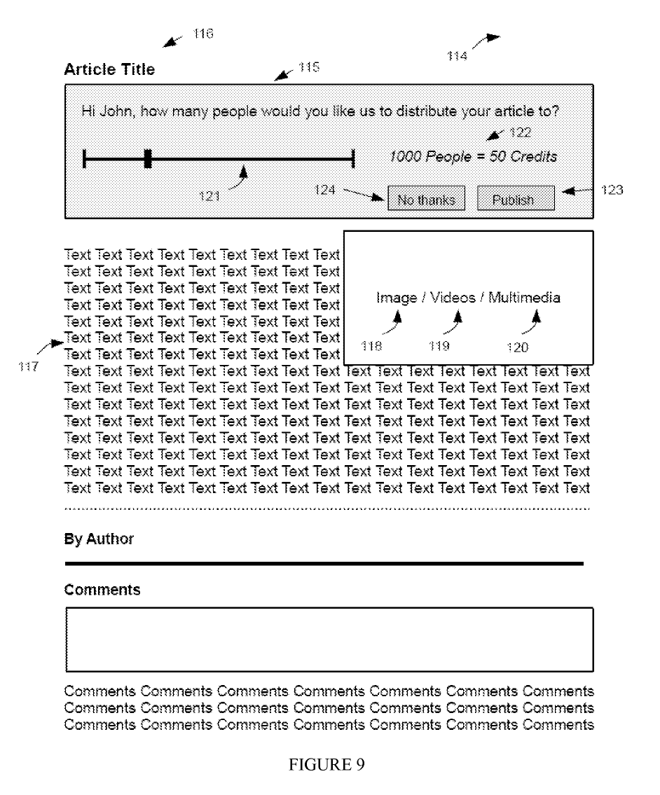

FIG. 9 illustrates one embodiment of an interface 114 for a user to extend the distribution of content through the network system after data has been uploaded and published. In this case, a system box 115 appears above the given content. The network system first analyzes the published content including the article title 116, text 117, images 118, video 119 and additional multimedia 120, as well as other data including keywords, related articles, data from the content group as well as other data related to the root site.

The system then determines how many readers exist across the system network that may be interested in this content. The distribution box 115 presents the number of available audience members to the end user with a scroll bar 121 and numbers 122. The user can move the scroll bar to the left or right to decide on the number of individuals they wish to target. The user can then hit the “Publish” button 123 to execute the request or hit the “No thanks” button 124 to cancel any distribution the network system offers. In the case of push of data through the network, other users accessing either the root site or an instance of the root site would receive the published data in substantially real time.

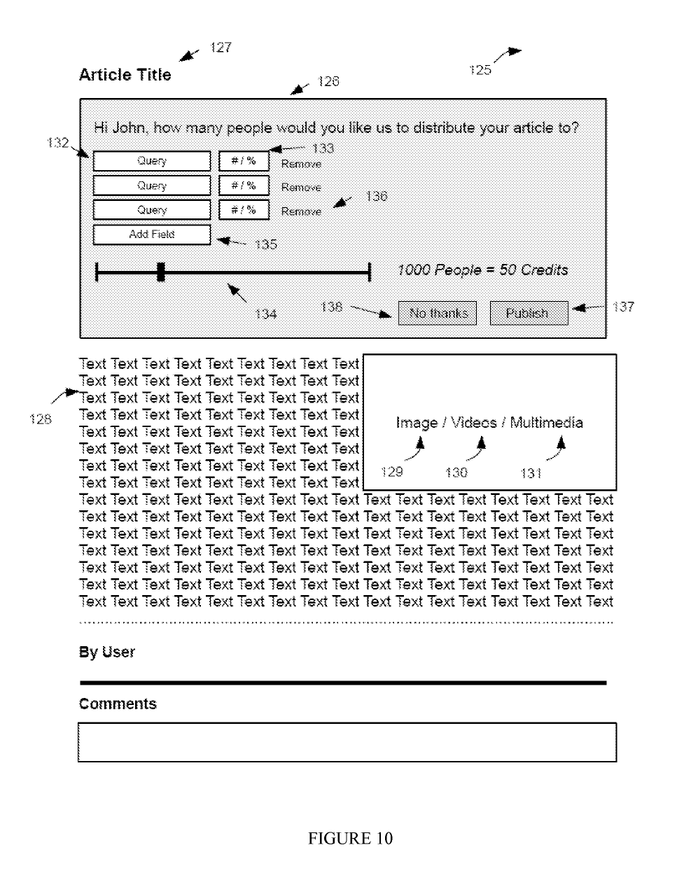

FIG. 10 illustrates another embodiment of an interface 125 where a user can extend the distribution of content through the network system after data has been uploaded and published. In this case, the system box 126 analyzes the article title 127, text 128, images 129, video 130 and multimedia 131 to ensure minimum formatting and quality variables are met. The system then analyzes the number of potential readers that may be interested in this content across the entire system network and presents the end user with a number of query tables 132, input boxes 133, a scroll bar 134 and the scroll bar's associated numbers. The user can specify which user types they would like to target within the query tables based on variables including gender, age, geo-location, platform type, specific platform, online destination, interest(s), personal data, as well as data directly or indirectly associated with the user base. The adjacent input boxes 133 will allow a user to set the given number of individuals to be targeted either by an actual number and/or a percentage. New queries can be added or removed by triggering the “Add Field” 135 or “Remove” buttons 136 respectively.

In one embodiment, the user can move the scroll bar to the left or right to decide on the total number of individuals he or she wishes to target. The user can then hit the “Publish” button 137 to execute the request or hit the “No thanks” 138 button to cancel any distribution being offered.

The following example is to illustrate the features described above with respect to FIGS. 9 and 10. A user writes an article on patent law and it gets published on the website. The user chooses to have this article distributed to a very specific group of people. Using the interface illustrated in FIG. 9 or 10, he selects individuals aged 30-50, having an income of 75,000$ or more, with interests in IT, patent laws, and corporate development. The article may be disseminated across Facebook™, iPhone™, and Blackberry™, to users who meet these criteria. The content of the article will be made available within each user's feed as well as in the substantially real-time instance of the website.

It should be understood that the user machine 18 may be any machine connectable to a network and adapted to exchange data with a server via the network. For example the user machine 18 can be a computer, a mobile telephone, or the like.

It should be noted that the present invention can be carried out as a method, can be embodied in a system, or a computer readable medium. The embodiments of the invention described above are intended to be exemplary only. The scope of the invention is therefore intended to be limited solely by the scope of the appended claims.

I/we claim:

1. A method for distributing content over a network, the method comprising:
generating a substantially real-time instance of a root website;
generating host site data in a frame of a host website, the frame comprising content of the host website and at least one blank segment; and
embedding the real-time instance of the root website in the host website frame via the at least one blank segment, thereby allowing access to the root site while remaining on the host website.

2. The method of claim 1, further comprising displaying a webpage of the host website including the real-time instance of the root website.

3. The method of claim 1, further comprising receiving the substantially real-time instance of the root website at a Web server hosting the host website where the frame of the host website is generated, wherein the embedding is done on the Web server.

4. The method of claim 3, further comprising transmitting the host website frame with the embedded real-time instance of the root website to a user machine for display.

5. The method of claim 1, further comprising receiving the substantially real-time instance of a root website and receiving the host site data in a frame of a host website at a user machine, wherein the embedding is done on the user machine.

6. The method of claim 1, wherein the real-time instance of the root website comprises text, hyperlinks, videos, audio, and images.

7. The method of claim 2, further comprising receiving a request from a user machine to perform at least one of deleting, adding, and modifying content from the substantially real-time instance of the root website while being connected to the host website, and updating the root website in accordance with the request.

8. The method of claim 7, wherein the receiving and updating are done on an instance generator server remote from a user machine and a web server hosting the host website.

9. The method of claim 1, wherein generating the substantially real-time instance of the root website and generating the frame of the host website is done in response to a request received from a user machine.

10. The method of claim 9, further comprising downloading an application on the user machine to allow access to the substantially real-time instance of the root website through the host website.

11. The method of claim 1, further comprising updating the substantially real-time instance of the root website.

12. The method of claim 11, further comprising notifying users of the substantially real-time instance of the root website that content therein has been updated.

13. The method of claim 1, wherein generating a substantially real-time instance of a root website comprises allowing access through the real-time instance to a parent website and at least one secondary website.

14. The method of claim 13, wherein the secondary website is created and accessed through the parent website.

15. A content distribution network comprising:
at least one server adapted to generate a substantially real-time instance of a root website and generate host site data in a frame of a host website, the frame comprising content of the host website and at least one blank segment; and
at least one user machine connected to the network, the user machine having at least one application running on a processor for displaying the frame comprising content of the host website and having the real-time instance of the root website embedded therein via the at least one blank segment, thereby allowing access to the root website while remaining on the host website, wherein embedding the substantially real-time instance of the root website into the frame of the host website is done on one of the at least one server and the user machine.

16. The content distribution network of claim 15, wherein the at least one server comprises a Web server hosting the host website and an instance generator server for generating the substantially real-time instance of the root website.

17. The content distribution network of claim 16, wherein the instance generator server is in communication with a root website server on which the root website is hosted.

18. The content distribution network of claim 15, wherein the at least one application has a web browser embedded therein, and running the at least one application will cause the web browser to open and bring the user to the substantially real-time instance of the root website through the host website.

19. The content distribution network of claim 15, wherein the at least one server updates the substantially real-time instance of the root website.

20. The content distribution network of claim 19, wherein the at least one server notifies users of the substantially real-time instance of the root website that content therein has been updated.

21. The content distribution network of claim 15, wherein the real-time instance of the root website comprises text, hyperlinks, videos, audio, and images.

22. The content distribution network of claim 15, wherein the substantially real-time instance of the root website comprises a parent website and at least one secondary website.

23. The content distribution network of claim 22, wherein the secondary website is available through the parent website.

24. The content distribution network of claim 15, wherein the at least one application allows at least one of deleting, adding, and modifying content from the substantially real-time instance of the root website while being connected to the host website, and the at least one server is adapted to update the root website in accordance with the request.

25. The content distribution network of claim 22, wherein the secondary website is available as a separate site/application that resides within the network.

26. The content distribution network of claim 15, wherein the at least one application has a web browser embedded that uses native code within the at least one application to render content, and running the at least one application will cause the web browser to open and bring the user to the substantially real-time instance of the root website through the host website
